(19) United States
(12) Patent Application Publication
(10) Pub. No.: US 2026/0292082 A1
(43) Pub. Date: Sep. 24, 2026

(54) IMAGE FORMING APPARATUS

(71) Applicant: CANON KABUSHIKI KAISHA, Tokyo (JP)

(72) Inventor: SHOZO YAMASAKI, Tokyo (JP)

(21) Appl. No.: 19/569,989

(22) Filed: Mar. 17, 2026

(30) Foreign Application Priority Data
Mar. 21, 2025 (JP) 2025-046978

(51) Int. Cl. H04N 1/00

(52) U.S. Cl. CPC H04N 1/0049; H04N 1/00013; H04N 1/00037; H04N 1/00411; H04N 1/0048; H04N 1/0083

(57) ABSTRACT

An image forming apparatus configured to form an image on a recording material, the image forming apparatus includes an apparatus body, a lighting portion disposed in the apparatus body and configured to be visually recognized by a user from an outside of the image forming apparatus, a control portion configured to control the lighting portion, an operation portion disposed in the apparatus body, and a connection portion configured to communicatively connect the control portion and the operation portion. The control portion is configured to cause the lighting portion to emit light in a predetermined mode on the basis of the control portion being unable to communicate with the operation portion.

### BACKGROUND

### Field of the Technology

The present disclosure relates to an image forming apparatuses such as a printer, a copying machine, a facsimile, or a multifunction printer.

### Description of the Related Art

An image forming apparatus such as a printer, a copying machine, a facsimile, or a multi-function printer has an operation panel attached to the image forming apparatus. The operation panel includes, for example, operation keys and operation buttons operated by a user who uses the image forming apparatus; and a display that can display various types of information inputted through user operations, an operating state of each component disposed in the image forming apparatus, and the like.

In recent years, the operation panel tends to be increased in size for increasing the visibility of the display and for increasing the amount of information displayed on the display. In addition, one operation panel can be replaced with another having a different size, in accordance with user needs. Japanese Patent Application Publication No. 2013-228554 proposes an image forming apparatus to which any one of a plurality of operation panels having different sizes can be selected and attached. The operation panel is not only physically attached to the casing of the image forming apparatus, but also communicatively connected to a main-body control portion or the like disposed in the casing of the image forming apparatus.

Japanese Patent Application Publication No. 2020-111009 proposes another image forming apparatus. In a case where a failure (error) of a display system occurs in an operation unit that includes a display device, and an image may not normally be displayed on the display device, the image forming apparatus causes a client terminal connected remotely to the image forming apparatus via a network, to display the error.

However, in an image forming apparatus that is not connected to a client terminal via a network, or in an image forming apparatus that does not have any network connection function, it is not possible to notify a user of the error in a case where a connection failure occurs in the operation panel and no image can be displayed on the display.

### SUMMARY

In view of the above-described issue, embodiments of the present disclosure provide an image forming apparatus that can notify a user of a connection failure of an operation panel without using the operation panel in a case where the connection failure occurs in the operation panel.

According to some embodiments of the present disclosure, an image forming apparatus configured to form an image on a recording material, the image forming apparatus includes an apparatus body, a lighting portion disposed in the apparatus body and configured to be visually recognized by a user from an outside of the image forming apparatus, a control portion configured to control the lighting portion, an operation portion disposed in the apparatus body, and a connection portion configured to communicatively connect the control portion and the operation portion. The control portion is configured to cause the lighting portion to emit light in a predetermined mode on the basis of the control portion being unable to communicate with the operation portion.

According to some embodiments of the present disclosure, an image forming apparatus configured to form an image on a recording material, the image forming apparatus includes an apparatus body, a driving portion configured to drive an operating member operably disposed in the apparatus body, a control portion configured to control the driving portion, an operation portion disposed in the apparatus body, and a connection portion configured to communicatively connect the control portion and the operation portion. The control portion is configured to cause the driving portion to cause the operating member to perform a predetermined operation on the basis of the control portion being unable to communicate with the operation portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming apparatus of the present embodiment.

FIG. 2A is a perspective view illustrating an operation panel that does not include a key-operation input portion.

FIG. 2B is a perspective view illustrating an operation panel that include a key-operation input portion.

FIG. 3 is a block diagram illustrating a control system of a main-body control portion.

FIG. 4 is a block diagram illustrating a control system of a panel control portion.

FIG. 5 is a top view illustrating a reader.

FIG. 6A is a schematic diagram illustrating an image forming apparatus in which an operation panel that does not include a key-operation input portion is attached to a casing.

FIG. 6B is a schematic diagram illustrating an image forming apparatus in which an operation panel that includes a key-operation input portion is attached to a casing.

FIG. 7 is a flowchart illustrating an error-notification control process of the present embodiment.

FIG. 8A illustrates an initial screen displayed on a display before the replacement work of an operation panel is performed.

FIG. 8B illustrates a cautions-after-replacement screen displayed on the display before the replacement work of the operation panel is performed.

FIG. 8C illustrates a recovery procedure screen displayed on the display before the replacement work of the operation panel is performed.

### DESCRIPTION OF THE EMBODIMENTS

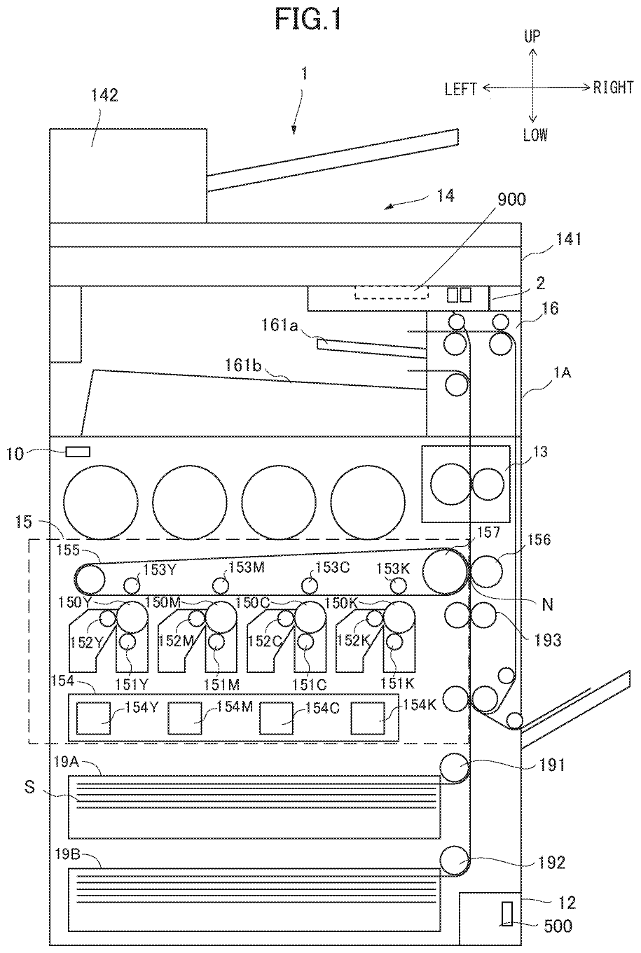

Hereinafter, the present embodiment will be described. First, an image forming apparatus of the present embodiment will be described with reference to FIG. 1. An image forming apparatus 1 illustrated in FIG. 1 is a color-image forming apparatus that uses the electrophotographic system. In the present embodiment, the intermediate-transfer tandem image forming apparatus 1 in which four-color image forming units are disposed side by side above an intermediate transfer belt 155 is used, as an example, because the apparatus has excellent adaptability to various types of recording materials S and excellent productivity in printing. Note that the recording materials S may be various types of sheets including a paper sheet such as a sheet or an envelope, a plastic film such as a sheet used for an overhead projector, and a cloth sheet.

As illustrated in FIG. 1, the image forming apparatus 1 includes a power supply apparatus 12 disposed in an apparatus body 1A. The power supply apparatus 12 is supplied with electric power from an external commercial power source (not illustrated), and supplies electric power for operating each device. The power supply apparatus 12 includes a main-power switch 500 for a user to switch (turn on and off) the electric power supplied from the commercial power source. For example, the main-power switch 500 is a seesaw or tactile switch.

In addition, a reader (document reading apparatus) 14 is disposed above the apparatus body 1A for optically reading an image of a document and converting the image into read data. The reader 14 includes a glass-like transparent document platen 141, and an automatic document feeder (ADF) 142 that serves as a conveyance portion. A document can be set on the ADF 142, and the document that is set on the ADF 142 is automatically conveyed to a reading position of the document.

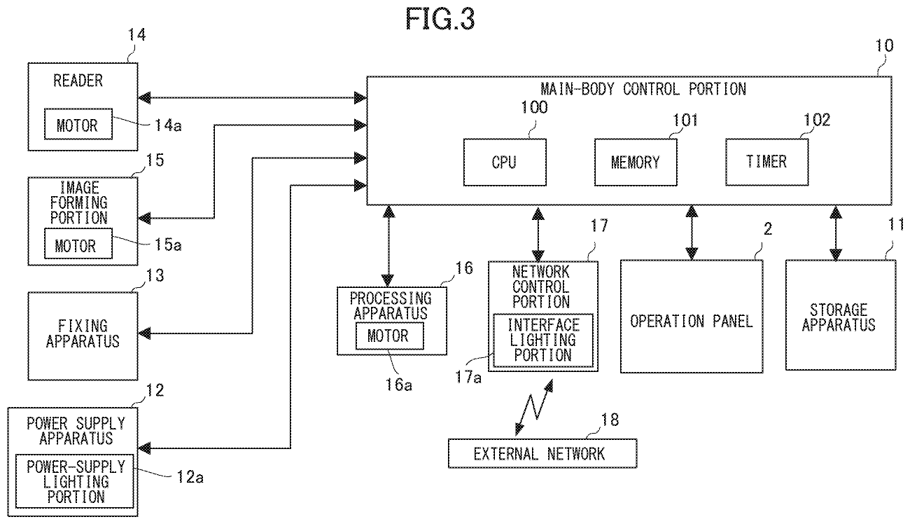

In addition, an operation panel 2 that serves as an operation portion is detachably attached to the apparatus body 1A. In the apparatus body 1A, a main-body connection portion 900 (i.e., a connector) is disposed. The main-body connection portion 900 serves as a connection portion that communicatively connects a below-described main-body control portion 10 (see FIG. 3) and the operation panel 2. The replacement work of the operation panel 2 is performed in a state where the main-power switch 500 is turned off (main-power OFF) and the electric power supplied by the power supply apparatus 12 is stopped. After the operation panel 2 is replaced with another, the main-power switch 500 is turned on (main-power ON), and the electric power is supplied again by the power supply apparatus 12. The operation panel 2 will be described later. Note that in the present specification, the side on which a user stands for operating the operation panel 2 for operating the image forming apparatus 1 is referred to as a front side (front surface side), the side opposite to the front side is referred to as a back side, the right side viewed from the front surface side is referred to as a right side, and the left side viewed from the front surface side is referred to as a left side. In addition, the upper side viewed from the front surface side is referred to as an upper side, and the lower side viewed from the front surface side is referred to as a lower side.

The image forming apparatus 1 includes an image forming portion 15 that forms an image on the recording material S. The image forming portion 15 includes photosensitive drums 150 (150Y, 150M, 150C, 150K), chargers 151 (151Y, 151M, 151C, 151K), and developing units 152 (152Y, 152M, 152C, 152K). The image forming portion 15 also includes primary transfer rollers 153 (153Y, 153M, 153C, 153K) and laser scanner units 154 (154Y, 154M, 154C, 154K). Furthermore, the image forming portion 15 includes the intermediate transfer belt 155 onto which toner images formed on the plurality of photosensitive drums 150 are primary-transferred, a secondary transfer outer roller 156 that secondary-transfers the toner images primary-transferred onto the intermediate transfer belt 155 to the recording material S, and a secondary transfer inner roller 157. The intermediate transfer belt 155 is stretched by tension rollers including the secondary transfer inner roller 157, and is driven and rotated.

The recording materials S are stacked on feeding cassettes 19A and 19B and fed by feed rollers 191 and 192 such that each recording material S is fed in accordance with an image forming timing in the image forming portion 15. The recording material S fed by each of the feed rollers 191 and 192 is conveyed to a registration roller pair 193. The registration roller pair 193 corrects the skew of the recording material S conveyed, and feeds the recording material S to a secondary transfer portion N at a predetermined timing in accordance with an image forming timing for the recording material S. That is, the registration roller pair 193 conveys the recording material S to the secondary transfer portion N in accordance with a timing at which the toner image borne on the intermediate transfer belt 155 reaches the secondary transfer portion N. The secondary transfer portion N is formed by the secondary transfer inner roller 157 and the secondary transfer outer roller 156 that are disposed so as to face each other via the intermediate transfer belt 155.

In parallel with the above-described conveyance process of the recording material S, the surface of the photosensitive drum 150 that is rotated is uniformly charged by the charger 151 in the image forming portion 15. The charged surface of the photosensitive drum 150 is exposed by the laser scanner unit 154. The laser scanner unit 154 irradiates the surface of the photosensitive drum 150 with a laser beam based on the reading data of a document read by the reader 14 or image data sent from an external apparatus (not illustrated) via a network, thereby forming an electrostatic latent image on the photosensitive drum 150. The electrostatic latent image formed on the photosensitive drum 150 is developed by the developing unit 152 using developer that contains toner. The toner image formed on the photosensitive drum 150 in the development is primary-transferred onto the intermediate transfer belt 155 by a predetermined pressure and a primary transfer bias being applied to the toner image by the primary transfer roller 153.

The above-described image forming process by the image forming portion 15 is performed for each of yellow (Y), magenta (M), cyan (C), and black (K), and thereby toner images of the respective colors are transferred onto the intermediate transfer belt 155 so as to be superposed on each other. In this manner, a full-color toner image is formed on the intermediate transfer belt 155. After that, with the rotation of the intermediate transfer belt 155, the full-color toner image is conveyed to the secondary transfer portion N. In the secondary transfer portion N, a predetermined pressure and a secondary transfer bias are applied to the toner image, so that the toner image is secondary-transferred from the intermediate transfer belt 155 to the recording material S. The recording material S onto which the toner image has been transferred is conveyed to a fixing apparatus 13. The fixing apparatus 13 causes rollers or a roller and a belt disposed so as to face each other, to apply a predetermined pressure to the recording material S; and causes a heat source, such as a heater, to apply heat to the recording material S, thereby fixing the toner image to the recording material S.

In the apparatus body 1A, a processing apparatus 16 that serves as a processing portion is additionally disposed as an option apparatus. The processing apparatus 16 can perform at least one of the stapling process, the punching process, and the binding process on the recording material S. Thus, in a case where a process such as the stapling process, the punching process, or the binding process is specified by a user, a recording material S that has been processed by the processing apparatus 16 is discharged to a discharging tray 161a. On the other hand, in a case where the process such as the stapling process, the punching process, or the binding process is not specified by a user, a recording material S that has not been processed by the processing apparatus 16 is discharged to a discharging tray 161b.

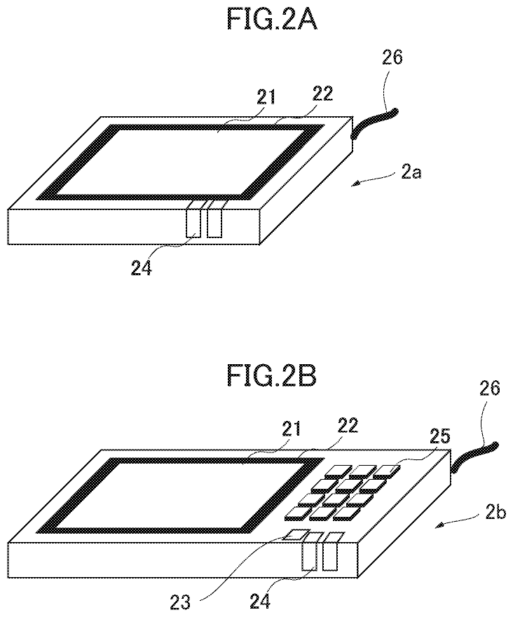

In the present embodiment, one operation panel 2 is disposed in the apparatus body 1A such that the operation panel 2 can be replaced with another that has a different size. Thus, the operation panels 2 that have sizes different from each other are prepared in advance. FIGS. 2A and 2B illustrate operation panels 2a and 2b having sizes different from each other. Each of the operation panels 2a and 2b includes a cable 26 that serves as a connection portion that communicatively connects the operation panel and the below-described main-body control portion 10 (see FIG. 3).

The operation panel 2a illustrated in FIG. 2A includes a display 21, such as a liquid crystal display, that can display various types of information; and a touch panel 22 that receives an operation instruction by a user, by detecting the operation performed on the display 21. Since the display 21 and the touch panel 22 are disposed so as to be put on each other, an image displayed on the display 21 is provided to a user through the touch panel 22. For example, a user can instruct the start of an image forming job (program) that forms an image on the recording material S, or can set the number of sheets on which images are to be formed and the size of the recording material S, by touching buttons or keys displayed on the screen of the display 21. Note that although the display 21 and the touch panel 22 are components separate from each other in the present embodiment, the present disclosure is not limited to this. For example, the operation panel 2a may include a touch panel display that has functions of both of the display 21 and the touch panel 22.

In addition, the operation panel 2a includes an LED group 24 in which a plurality of LEDs is arranged. Thus, the operation panel 2a can notify a user of the state of the image forming apparatus 1 by using the LED group 24. In a case where the LED group 24 is used, various states can be notified to a user by using corresponding lighting patterns of the LEDs. Examples of the states include a state where a jam in which the recording material S is stuck when conveyed in an image forming job is occurring, a state where any device has a failure, and a state where a door openably and closably disposed in the image forming apparatus 1 is open.

Like the above-described operation panel 2a, the operation panel 2b illustrated in FIG. 2B includes the display 21, the touch panel 22, and the LED group 24; and in addition to these components, includes a key-operation input portion 25. The key-operation input portion 25 is physical operation keys or operation buttons (so-called hard keys) that can be operated by a user, and is disposed outside the area in which the display 21 and the touch panel 22 are disposed. For example, the key-operation input portion 25 may be an operation key that can instruct the start of an image forming job (program), numeric keys that can accept a numerical value such as the number of sheets on which images are to be formed, or a power saving key that instructs the transition to a power saving mode. The size of the operation panel 2b is larger than the size of the above-described operation panel 2a in a case where the display 21 of the operation panel 2b is larger than that of the above-described operation panel 2a. In addition, even if the size of the display 21 of the operation panel 2a is equal to the size of the display 21 of the operation panel 2b, the size of the operation panel 2b is larger than the size of the operation panel 2a by the size of the key-operation input portion 25.

Each of the operation panels 2 (2a and 2b) may include a speaker 23 that emits a sound. In this case, the state of the image forming apparatus 1 can be notified to a user by using the speaker 23. In a case where the speaker 23 is used, the state of the image forming apparatus 1 can be notified to a user by using a sound generation pattern that is determined in advance in accordance with a corresponding state of the image forming apparatus 1. The above-described display 21, LED group 24, and speaker 23 are collectively disposed in the operation panel 2, integrally with the operation panel 2, for increasing the performance of notification to users and reducing cost.

### Control System of Main-Body Control Portion

As illustrated in FIG. 1, the image forming apparatus 1 includes the main-body control portion 10 that controls the whole of the image forming apparatus 1. Hereinafter, the control performed by the main-body control portion 10 for the whole of the image forming apparatus 1 will be described with reference to FIG. 3 while referring to FIG. 1. Note that although various components other than components illustrated in FIG. 3 are connected to the main-body control portion 10, the illustration and description thereof will be omitted.

As illustrated in FIG. 3, the main-body control portion 10 includes a central processing unit (CPU) 100, a memory 101, and a timer 102. The main-body control portion 10 is communicatively and electrically connected with devices such as the power supply apparatus 12, the operation panel 2, the fixing apparatus 13, the reader 14, the image forming portion 15, and the processing apparatus 16. The power supply apparatus 12 converts the electric power, supplied from a commercial power source (not illustrated) via a socket and a plug, into electric power necessary for operating the above-described each device and supplies the electric power to the device.

A storage apparatus 11 stores various types of programs related to the control of the image forming apparatus 1, various display images, and the like. The various types of programs stored in the storage apparatus 11 are a group of software that can be executed by the main-body control portion 10 for performing various types of control. In addition, the various display images stored in the storage apparatus 11 are display data for screens displayed on the display 21 of the operation panel 2.

The CPU 100 can control the operation of each device connected to the main-body control portion 10, by reading and executing the program stored in the storage apparatus 11. The memory 101 temporarily stores data, such as a result of a computational processing obtained by the CPU 100 executing the program. That is, the CPU 100 controls the operation panel 2, the fixing apparatus 13, the reader 14, the image forming portion 15, the processing apparatus 16, and the like connected to the main-body control portion 10, based on the program stored in the storage apparatus 11, by using the memory 101 as a work area. In a case where the CPU 100 controls the above-descried devices, the CPU 100 can cause the display 21 to display various images, by sending display images read from the storage apparatus 11, to the display 21.

The timer 102 measures the time in a case where the main-body control portion 10 performs various processes. For example, the main-body control portion 10 transitions the mode of the image forming apparatus 1 from a standby mode to a sleep mode (i.e., a power saving mode), based on a value counted by the timer 102. The standby mode is a mode for putting each device on standby in a state where the image forming apparatus 1 can immediately form an image on the recording material S. The sleep mode is a mode for making the power consumption lower than that of the standby mode, by temporarily stopping the electric power supplied to some of the plurality of devices connected to the main-body control portion 10. For example, in the sleep mode, the main-body control portion 10 stops the electric power supplied to the display 21.

A network control portion 17 that serves as a communication interface portion sends/receives image data and various type of information to/from an external apparatus (e.g., a personal computer or a host computer) that is communicatively connected with the network control portion 17 via a wired LAN or a wireless LAN, which is an external network 18.

### Control System of Operation Panel

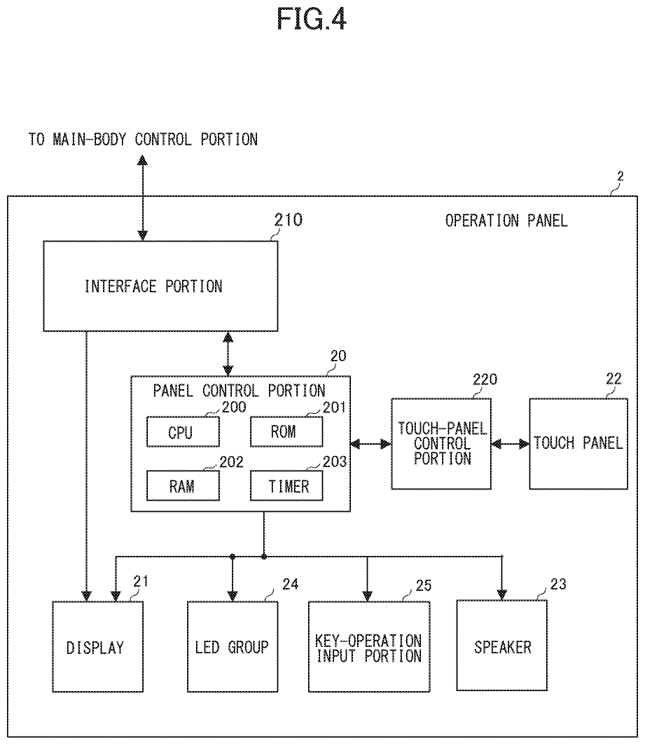

As described above, the main-body control portion 10 is connected with the operation panel 2, and controls the operation panel 2. Hereinafter, a control system of the operation panel 2 will be described in detail with reference to FIG. 4.

As illustrated in FIG. 4, the operation panel 2 includes a panel control portion 20. In the present embodiment, the panel control portion 20 substantially controls the operation panel 2 under the control of the main-body control portion 10. The panel control portion 20 includes a central processing unit (CPU) 200, a read only memory (ROM) 201, a random access memory (RAM) 202, and a timer 203.

The ROM 201 stores a control program that controls the operation panel 2, various types of data, and the like. The RAM 202 stores information obtained from the main-body control portion 10 and related to the control of the operation panel 2, and information on the connection between the operation panel 2 and the image forming apparatus 1. The information on the control of the operation panel 2 includes display data for screens; information on the state of the image forming apparatus 1, such as the standby mode, the sleep mode, and error detection; and count information such as the number of sheets on which images have been formed. The information on the connection between the operation panel 2 and the image forming apparatus 1 includes connection information that indicates the connection state between the image forming apparatus 1 and the operation panel 2.

The CPU 200 controls each device connected to the panel control portion 20, by executing the control program stored in the ROM 201 and using the RAM 202 as a work area. Specifically, the panel control portion 20 is connected with the display 21, a touch-panel control portion 220, the LED group 24, the key-operation input portion 25, and the like. The timer 203 measures the time in a case where the panel control portion 20 performs various processes.

The display 21 is a display portion that can display the control program stored in advance in the ROM 201, information on various types of data, and various types of information sent from the main-body control portion 10 and stored in the RAM 202. The panel control portion 20 selectively switches the operation between an operation that causes the display 21 to display an image related to the control program stored in advance in the ROM 201 and information on the various types of data, and an operation that causes the display 21 to display an image related to the various types of information stored in the RAM 202. The touch panel 22 that detects a touch operation performed by a user on the screen is disposed so as to be put on the display 21. The display 21 displays an image that is provided to a user through the touch panel 22. The touch panel 22 detects which part of the display 21 a user has touched. The touch-panel control portion 220 sends a result detected by the touch panel 22, to the panel control portion 20. For example, a user can instruct the start of an image forming job (program) that forms an image on the recording material S, or can set the number of sheets on which images are to be formed and the size of the recording material S, by touching a button or a key displayed on the screen of the display 21.

In addition, the panel control portion 20 is connected with the key-operation input portion 25. The key-operation input portion 25 is physical operation keys or operation buttons (so-called hard keys) that can be operated by a user, and is disposed in an area of the operation panel 2 other than the area in which the display 21 is disposed. For example, the key-operation input portion 25 includes an operation key that can instruct the start of an image forming job (program), and numeric keys that can accept a numerical value such as the number of sheets on which images are to be formed.

In addition, the panel control portion 20 is connected with the LED group 24 in which a plurality of LEDs is arranged. In addition, the panel control portion 20 may be connected with the speaker 23 that emits a sound. Thus, the panel control portion 20 can notify a user of the state of the image forming apparatus 1 by using the LED group 24 and the speaker 23.

The operation panel 2 includes an interface portion 210 (e.g., a connector) for communicatively connecting the operation panel 2 and the main-body control portion 10. The interface portion 210 that serves as a connection portion is connected with the panel control portion 20. The panel control portion 20 can control devices, such as the display 21, the touch-panel control portion 220, the LED group 24, and the key-operation input portion 25, under the control of the main-body control portion 10 performed via the interface portion 210. In addition, the interface portion 210 is connected with the display 21. Since the display 21 is connected with not only the panel control portion 20 but also the interface portion 210, the main-body control portion 10 can directly control the display 21 not via the panel control portion 20.

For example, in a case where the main-body control portion 10 detects an operation error of the image forming apparatus 1, the main-body control portion 10 notifies a user of the error by causing the display 21 to display an error screen, by outputting the error information to the display 21. In addition, the main-body control portion 10 outputs the error information to the panel control portion 20, and thereby notifies a user of the error by causing the panel control portion 20 to turn on the LED group 24 or emit an error sound from the speaker 23.

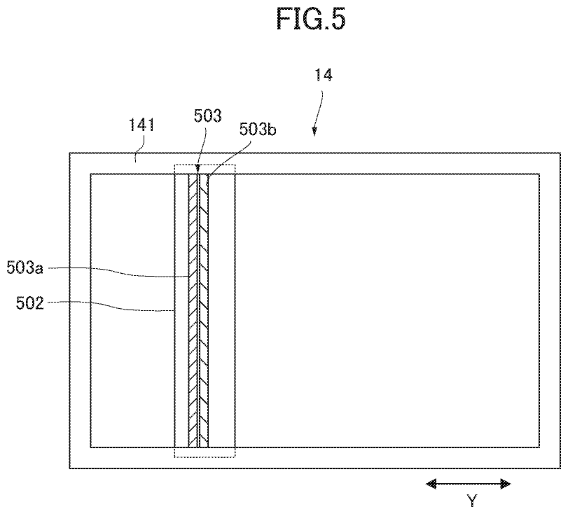

Next, the reader 14 will be described with reference to FIG. 5. As illustrated in FIG. 5, the reader 14 includes, in addition to the above-described document platen 141 and ADF 142 (see FIG. 1), a reading portion 502 that can optically read an image of a document. The reading portion 502 can move back and forth in a direction indicated by an arrow Y, with respect to the document platen 141. The reading portion 502 includes a reading light source 503 and a motor 14a (see FIG. 3). The reading light source 503 includes a light emitting portion 503a that emits light to a document, and a light receiving portion 503b that receives the light reflected from the document. The motor 14a moves the reading portion 502 in the direction indicated by the arrow Y. The light emitting portion 503a is a plurality of LEDs arranged side by side in a direction that intersects the direction indicated by the arrow Y. The light emitting portion 503a can be visually recognized by a user from the outside.

In a case where the reading portion 502 reads an image of a document placed on the document platen 141, the reading portion 502 is controlled so as to move in a state where the light emitting portion 503a emits light. In a case where the reading portion 502 does not read a document, the reading portion 502 is on standby at a home position on the left side of the document platen 141. In a case where the reading portion 502 reads a document, the reading portion 502 reads an image of the document while moving rightward from the home position. After that, the reading portion 502 moves leftward and returns to the home position. Note that the reader 14 may not include the ADF 142. In this case, the reader 14 causes the reading portion 502 to read an image of a document manually placed on the document platen 141 by a user.

The main-body control portion 10 connected with the reader 14 receives the read data of the image that is read by the reading portion 502. The main-body control portion 10 can use the read data, received by the main-body control portion 10, for forming an image, or can cause the network control portion 17 to send the read data to an external host computer connected to the external network 18.

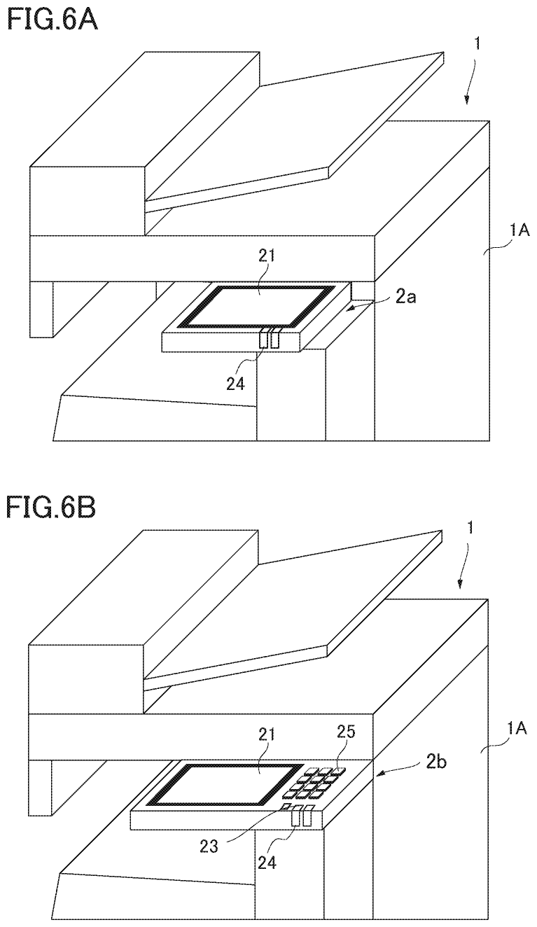

As described above, in the present embodiment, the operation panels 2A and 2B having different sizes are prepared in advance, and one of the operation panels 2A and 2B is disposed in the apparatus body 1A such that one operation panel can be replaced with another. FIG. 6A illustrates the image forming apparatus 1 in which the operation panel 2a that does not include the key-operation input portion 25 is attached to the apparatus body 1A. FIG. 6B illustrates the image forming apparatus 1 in which the operation panel 2b that includes the key-operation input portion 25 is attached to the apparatus body 1A. In the image forming apparatus 1 of the present embodiment, the operation panel 2a attached in advance to the apparatus body 1A can be detached, and can be replaced with the larger operation panel 2b.

By the way, in a case where the operation panel 2a is replaced with the operation panel 2b, if the operation panel 2b is not properly attached, the main-body control portion 10 and the operation panel 2b are not communicatively connected with each other via the interface portion 210. In this case, the operation panel 2b may be in a state (referred to also as a connection failure) where the operation panel 2b is unable to communicate. If the main-power switch 500 is turned on and the electric power is supplied again by the power supply apparatus 12 after the operation panel 2a is replaced with the operation panel 2b, the main-body control portion 10 detects the connection failure when checking the connection between the main-body control portion 10 and the operation panel 2b. However, even if the main-body control portion 10 detects the connection failure, the error information is not received by the display 21 and the panel control portion 20 of the operation panel 2b because the main-body control portion 10 and the operation panel 2b are not communicatively connected with each other. As a result, the display 21 displays no images, the LED group 24 turns on no LED, and the speaker 23 emits no sound. That is, the connection failure cannot be notified to a user via the operation panel 2b, which the operation panel 2a has been replaced with.

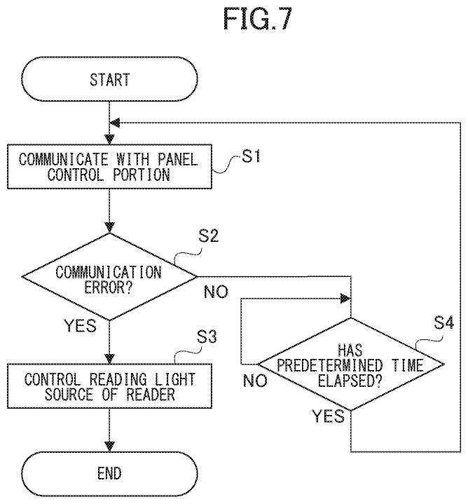

In view of this point, in the present embodiment, in a state where the main-body control portion 10 and the operation panel 2 are not communicatively connected with each other via the interface portion 210, the main-body control portion 10 can notify a user of the connection failure between the main-body control portion 10 and the operation panel 2 in a case where the main-body control portion 10 and the operation panel 2 are unable to communicate with each other. Hereinafter, an error-notification control process of the present embodiment for achieving the notification will be described with reference to FIG. 7 while referring to FIGS. 3 and 4. The error-notification control process illustrated in FIG. 7 is started by the main-body control portion 10 in a case where the main-power switch 500 is turned on after the replacement of the operation panel 2 and the electric power is supplied again by the power supply apparatus 12.

As illustrated in FIG. 7, if the electric power is supplied from the power supply apparatus 12, then the main-body control portion 10 communicates with the panel control portion 20 (S1). In the communication, the main-body control portion 10 sends/receives a signal to/from the panel control portion 20 for checking the connection between the main-body control portion 10 and the operation panel 2. The main-body control portion 10 determines whether the communication between the main-body control portion 10 and the panel control portion 20 has been performed normally, by receiving a notification signal sent from the panel control portion 20, or by reading predetermined data stored in the ROM 201 of the panel control portion 20 (S2).

If the communication between the main-body control portion 10 and the panel control portion 20 has not been performed normally (S2: YES), then the main-body control portion 10 determines the connection failure (i.e., a communication error) between the main-body control portion 10 and the operation panel 2, and notifies a user of the connection failure of the operation panel 2 by using the light emitting portion 503a, by controlling the reading light source 503 of the reader 14 (S3). In this case, the main-body control portion 10 causes the plurality of LEDs of the light emitting portion 503a to emit light with a predetermined lighting pattern. For example, as the lighting pattern for notifying a user of the connection failure of the operation panel 2, the main-body control portion 10 causes all the plurality of LEDs of the light emitting portion 503a to emit light (full lighting). In this case, the light emitting portion 503a may be caused to emit light until the main-power switch 500 is turned off (main-power OFF), or may be caused to emit light until a predetermined time (e.g., a few minutes) has elapsed since the main-power switch 500 was turned on (main-power ON). In this manner, in a case where the operation panel 2 is unable to communicate when the main power of the image forming apparatus 1 is turned on, the light emitting portion 503a is caused to emit light with a predetermined lighting pattern.

If the main-body control portion 10 communicates normally with the panel control portion 20 (S2: NO), that is, if the main-body control portion 10 and the operation panel 2 are communicatively connected with each other via the interface portion 210, then the main-body control portion 10 starts the timer 102 and stops the process until a predetermined time (e.g., 1 second) has elapsed (S4: NO). If the predetermined time has elapsed (S4: YES), then the main-body control portion 10 returns to Step S1 and repeats the process.

This is because even if the main-body control portion 10 and the operation panel 2 are communicatively connected with each other, the state (connection failure) where the main-body control portion 10 and the operation panel 2 are not communicatively connected with each other may be caused, with use, by the deterioration or break of the main-body connection portion 900, the interface portion 210, or the cable 26 used for connecting the main-body control portion 10 and the operation panel 2. Thus, even in a case where the main-body control portion 10 and the operation panel 2 are communicatively connected with each other, the main-body control portion 10 regularly communicates with the panel control portion 20 for detecting the connection failure between the main-body control portion 10 and the operation panel 2. Thus, even in a case where the main-body control portion 10 and the operation panel 2 become unable to communicate with each other in a state where the main power of the image forming apparatus 1 has been turned on, the light emitting portion 503a is caused to emit light until a predetermined time has elapsed since the operation panel 2 became unable to communicate, or until the main power is turned off.

Note that the lighting pattern of the light emitting portion 503a for notifying a user of the connection failure of the operation panel 2 may be any lighting pattern. For example, instead of the full lighting of the light emitting portion 503a, the light emitting portion 503a may be caused to blink in predetermined cycles. In addition, the lighting pattern is not limited to the lighting or blinking. For example, the lighting color of each LED of the light emitting portion 503a may be changed from white, used for reading a document (in a normal operation), to another color, or a plurality of colors may be selected sequentially.

### Screen Displayed on Operation Panel

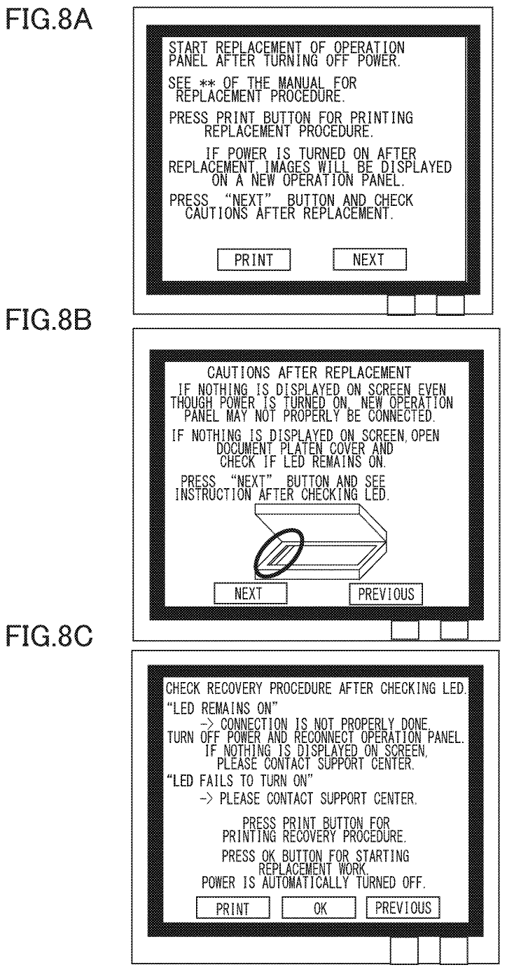

As described above, in the present embodiment, in a case where the connection failure of the operation panel 2 occurs, the light emitting portion 503a is caused to emit light with a predetermined lighting pattern, so that the connection failure can be notified to a user. For achieving this, the user has to know that the lighting pattern of the light emitting portion 503a for notifying the connection failure of the operation panel 2 is different from a normal lighting pattern. Thus, in the present embodiment, the lighting pattern for notifying the connection failure of the operation panel 2 is displayed on the display 21 before the user performs the replacement work of the operation panel 2. This point will be described with reference to FIGS. 8A to 8C.

First, a user selects and operates an operation-panel replacement work button in a menu screen (not illustrated) displayed on the display 21. If the operation-panel replacement work button is operated, a replacement procedure screen illustrated in FIG. 8A is displayed. As illustrated in FIG. 8A, on the replacement procedure screen, a caution instructing a user to start the replacement work after turning off the main-power switch 500 of the image forming apparatus 1 is displayed. In addition, on the replacement procedure screen, a section of the replacement procedure in the manual in which the usage of the image forming apparatus 1 is written, the method of printing the replacement procedure, and the like are displayed. If a “print” button of the replacement procedure screen is operated, the image forming apparatus 1 operates, and outputs the recording material S on which the replacement procedure is printed.

Furthermore, on the replacement procedure screen, the operation of the operation panel 2 after the replacement, and cautions after the replacement are displayed. If a “next” button of the replacement procedure screen is operated, a cautions-after-replacement screen on which the detail of the cautions after replacement is described is displayed. As illustrated in FIG. 8B, on the cautions-after-replacement screen, the method of checking the connection failure of the operation panel 2 in a case where nothing is displayed on the display 21 even though the main-power switch 500 of the image forming apparatus 1 is turned on is displayed. In FIG. 8B, the method of checking the connection failure of the operation panel 2 is to check if the LEDs remain on (i.e., a predetermined mode), which is a lighting pattern of the light emitting portion 503a of the reader 14. In addition, for making it easy for a user to check the position of the light emitting portion 503a, an image that indicates the position of the light emitting portion 503a is displayed on the cautions-after-replacement screen.

If a “previous” button of the cautions-after-replacement screen is operated, the replacement procedure screen is displayed again. If a “next” button of the cautions-after-replacement screen is operated, a recovery procedure screen is displayed. As illustrated in FIG. 8C, on the recovery procedure screen, a recovery procedure corresponding to a lighting pattern of the light emitting portion 503a is displayed. In FIG. 8C, in a case where the light emitting portion 503a remains on as a lighting pattern, the connection failure of the operation panel 2 has been occurring. Thus, the recovery procedure displayed on the recovery procedure screen for eliminating the connection failure of the operation panel 2 instructs a user to reconnect the operation panel 2. The connection failure of the operation panel 2 occurs mainly because a connector or a cable for communicatively connecting the main-body control portion 10 and the operation panel 2 is not properly fit in the operation panel 2. Thus, for properly fitting the connector or the cable in the operation panel 2, the procedure for instructing a user to reconnect the operation panel 2 is displayed. In addition, on the recovery procedure screen, an instruction for a user to contact a support center in a case where the connection failure is not eliminated even though the operation panel 2 is reconnected is displayed.

On the recovery procedure screen, another instruction for a user to contact the support center also in a case where the reading light source 503 completely fails to turn on. This is because if the reading light source 503 completely fails to turn on, the reading light source 503 itself may have a failure. If a “print” button of the recovery procedure screen is operated, the image forming apparatus 1 operates, and outputs the recording material S on which the recovery procedure is printed. As described above, the recording material S on which the replacement procedure is printed, and the recording material S on which the recovery procedure is printed can be output for a user to check the replacement procedure and the recovery procedure even if the connection failure occurs in the operation panel 2 and the above-described replacement procedure screen and recovery procedure screen are not displayed on the display 21. If a “previous” button of the recovery procedure screen is operated, the cautions-after-replacement screen is displayed again. If an “OK” button of the recovery procedure screen is operated, the automatic power off of the image forming apparatus 1 is performed.

As described above, in the present embodiment, in a case where the connection failure between the main-body control portion 10 and the operation panel 2 occurs, the connection failure is notified to a user by using the light emitting portion 503a of the reader 14. In a case where the operation panel 2 is unable to communicate, the light emitting portion 503a is caused to emit light with a predetermined lighting pattern that indicates the connection failure of the operation panel 2. That is, even in a case where the connection failure between the main-body control portion 10 and the operation panel 2 occurs and the operation panel 2 cannot be used, the occurrence of the connection failure of the operation panel 2 can be notified to a user by causing the light emitting portion 503a to emit light, instead of using the operation panel 2.

### Other Embodiments

In the above-described embodiment, in a case where the connection failure of the operation panel 2 occurs, the connection failure of the operation panel 2 is notified to a user by causing the light emitting portion 503a to emit light with a predetermined lighting pattern. However, the present disclosure is not limited to this. For example, in a case where the main-body control portion 10 and the operation panel 2 are unable to communicate with each other, the main-body control portion 10 may operate the reading portion 502 (i.e., an operating member) of the reader 14 by controlling the motor 14a disposed in the reader 14 and serving as a driving portion. For example, as a predetermined operating pattern (i.e., a predetermined operation) for notifying a user of the connection failure of the operation panel 2, the reading portion 502 may move back and forth in the direction indicated by the arrow Y, between the home position and the position of an edge portion of the document platen 141 opposite to the home position, or between the home position and a position between the home position and the edge portion of the document platen 141 in the direction indicated by the arrow Y. If the motor 14a is driven, operating noise occurs; and if the reading portion 502 is moved, the reader 14 vibrates. In this case, since the motor 14a emits the operating noise and the reader 14 vibrates, a user notices the operation of the reading portion 502, and realizes the connection failure of the operation panel 2 by checking the operation of the reading portion 502. Note that the reading portion 502 may be operated with a predetermined operating pattern while the light emitting portion 503a is caused to emit light with a predetermined lighting pattern.

In the above-described embodiments, the connection failure of the operation panel 2 is notified to a user by causing the light emitting portion 503a to emit light with a predetermined lighting pattern, or by operating the reading portion 502 with a predetermined operating pattern. However, the present disclosure is not limited to this. Some types of the image forming apparatus 1 may not include the reader 14. Hereinafter, a method of notifying the connection failure between the operation panel 2 and the main-body control portion 10 in a single-function printer in which the image forming apparatus 1 does not include the reader 14 will be described.

For example, an interface lighting portion 17a (see FIG. 3) of the network control portion 17 may be used for notifying a user of the connection failure of the operation panel 2. Normally, the interface lighting portion 17a can be turned on in accordance with the communication state between the network control portion 17 and an external apparatus connected to the network control portion 17 via the external network 18. The interface lighting portion 17a includes two types of LEDs that can be visually recognized by a user from the outside. One is a connection-state notification LED that indicates the connection between the network control portion 17 and the external network 18, and continues to emit light while the network control portion 17 is connected to the external network 18. The other is a communication-state notification LED that indicates the communication state between the network control portion 17 and an external apparatus via the external network 18, and blinks in accordance with the transmission and reception of communication data performed via the external network 18. Normally, the interface lighting portion 17a is controlled by a network controller (not illustrated) of the network control portion 17. If a network cable (not illustrated) is not connected to the network control portion 17, the interface lighting portion 17a does not turn on. Normally, the interface lighting portion 17a is controlled by the network controller in accordance with the network control, and is not directly controlled by the main-body control portion 10.

In the present embodiment, in a case where the connection failure of the operation panel 2 occurs, the main-body control portion 10 causes the interface lighting portion 17a to emit light with a predetermined mode by sending a command to the network controller and changing a register of the network controller. For example, the main-body control portion 10 causes the connection-state notification LED to blink, and causes the communication-state notification LED to continue to emit light. In addition, if the network cable is not connected to the network control portion 17, the main-body control portion 10 may cause both of the connection-state notification LED and the communication-state notification LED to emit light. That is, the main-body control portion 10 notifies a user of the connection failure of the operation panel 2 by causing the connection-state notification LED and the communication-state notification LED to emit light in a mode different from the normal mode.

In addition, a power-supply lighting portion 12a (see FIG. 3) of the power supply apparatus 12 may be used for notifying a user of the connection failure of the operation panel 2. As described above, the power supply apparatus 12 includes the main-power switch 500 for a user to switch (turn on and off) the electric power supplied from the commercial power source. For example, the main-power switch 500 is a seesaw or tactile switch. Some types of the power supply apparatus 12 include the power-supply lighting portion 12a (i.e., a power-supply-state notification LED) disposed in the vicinity of the main-power switch 500 so as to be able to be visually recognized by a user from the outside. The power-supply lighting portion 12a notifies a user of a power-supply ON state when the main-power switch 500 is turned on. Normally, the power-supply lighting portion 12a continues to emit light in the power-supply ON state. In the present embodiment, the main-body control portion 10 causes the power-supply lighting portion 12a to emit light in a predetermined mode in a case where the connection failure of the operation panel 2 occurs. For example, the main-body control portion 10 causes the power-supply lighting portion 12a to blink. That is, the main-body control portion 10 notifies a user of the connection failure of the operation panel 2 by causing the power-supply lighting portion 12a (i.e., a power-supply-state notification LED) to emit light in a mode different from the normal mode.

Note that any lighting portion, such as an LED, other than the above-described light emitting portion 503a, the interface lighting portion 17a, and the power-supply lighting portion 12a and disposed so as to be able to be visually recognized by a user from the outside may be used for notifying a user of the connection failure of the operation panel 2 if the lighting portion can be caused to emit light in a lighting pattern different from the normal lighting pattern.

Furthermore, an operating member, such as the processing apparatus 16 or the ADF 142, may be used for notifying a user of the connection failure of the operation panel 2. In a case where the connection failure of the operation panel 2 occurs, the main-body control portion 10 notifies a user of the connection failure of the operation panel 2 by continuously driving the operating member.

Note that any operating member other than the above-described reading portion 502, the processing apparatus 16, and the ADF 142 may be used for notifying a user of the connection failure of the operation panel 2 if the operating member is movably disposed in the apparatus body 1A, the operating state of the operating member can be checked by a user, and the operating member can operate with an operating pattern different from the normal operating pattern.

Note that the above-described embodiments are not limited to the electrophotographic image forming apparatus, and may be applied to an image forming apparatus, such as an ink-jet system, that has another system.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-046978 filed Mar. 21, 025, which is hereby incorporated by reference herein in its entirety.

What is claimed is:

1. An image forming apparatus configured to form an image on a recording material, the image forming apparatus comprising:
an apparatus body;
a lighting portion disposed in the apparatus body and configured to be visually recognized by a user from an outside of the image forming apparatus;
a control portion configured to control the lighting portion;
an operation portion disposed in the apparatus body; and
a connection portion configured to communicatively connect the control portion and the operation portion,
wherein the control portion is configured to cause the lighting portion to emit light in a predetermined mode on the basis of the control portion being unable to communicate with the operation portion.

2. The image forming apparatus according to claim 1, wherein the control portion is configured to cause the lighting portion to emit light in the predetermined mode in a case where the control portion is unable to communicate with the operation portion when main power of the image forming apparatus is turned on.

3. The image forming apparatus according to claim 2, wherein the control portion is configured to cause the lighting portion to emit light in the predetermined mode until a predetermined time has elapsed since the main power was turned on.

4. The image forming apparatus according to claim 2, wherein the connection portion is a cable configured to connect the control portion and the operation portion, and
wherein in a case where the control portion and the operation portion are not connected with each other via the cable, the control portion is unable to communicate with the operation portion.

5. The image forming apparatus according to claim 1, wherein the control portion is configured to cause the lighting portion to emit light in the predetermined mode in a case where the control portion and the operation portion are unable to communicate with each other in a state where main power of the image forming apparatus has been turned on.

6. The image forming apparatus according to claim 5, wherein the control portion is configured to cause the lighting portion to emit light in the predetermined mode until a predetermined time has elapsed since the control portion became unable to communicate with the operation portion.

7. The image forming apparatus according to claim 5, wherein the operation portion includes a display portion, and
wherein in a case where the operation portion is communicatively connected with the connection portion, in accordance with an operation performed on the operation portion, the display portion displays an image indicating the predetermined mode in which the lighting portion is caused to emit light in a case where the control portion and the operation portion are unable to communicate with each other.

8. The image forming apparatus according to claim 1, wherein the operation portion is configured to be detachably attached to the apparatus body.

9. The image forming apparatus according to claim 1, further comprising:
a document reading apparatus including a light emitting portion for reading an image of a document,
wherein the lighting portion is the light emitting portion.

10. The image forming apparatus according to claim 1, further comprising:
a communication interface portion configured to be communicatively connected with an external apparatus; and
an interface lighting portion configured to emit light in accordance with a communication state between the external apparatus and the communication interface portion,
wherein the lighting portion is the interface lighting portion.

11. An image forming apparatus configured to form an image on a recording material, the image forming apparatus comprising:
an apparatus body;
a driving portion configured to drive an operating member operably disposed in the apparatus body;
a control portion configured to control the driving portion;
an operation portion disposed in the apparatus body; and
a connection portion configured to communicatively connect the control portion and the operation portion,
wherein the control portion is configured to cause the driving portion to cause the operating member to perform a predetermined operation on the basis of the control portion being unable to communicate with the operation portion.

12. The image forming apparatus according to claim 11, wherein the control portion is configured to cause the driving portion to cause the operating member to perform the predetermined operation in a case where the control portion is unable to communicate with the operation portion when main power of the image forming apparatus is turned on.

13. The image forming apparatus according to claim 12, wherein the control portion is configured to cause the driving portion to cause the operating member to perform the predetermined operation until a predetermined time has elapsed since the main power was turned on.

14. The image forming apparatus according to claim 12, wherein the connection portion is a cable configured to connect the control portion and the operation portion, and
wherein in a case where the control portion and the operation portion are not connected with each other via the cable, the control portion is unable to communicate with the operation portion.

15. The image forming apparatus according to claim 11, wherein the control portion is configured to cause the driving portion to cause the operating member to perform the predetermined operation in a case where the control portion and the operation portion are unable to communicate with each other in a state where main power of the image forming apparatus has been turned on.

16. The image forming apparatus according to claim 15, wherein the control portion is configured to cause the driving portion to cause the operating member to perform the predetermined operation until a predetermined time has elapsed since the control portion became unable to communicate with the operation portion.

17. The image forming apparatus according to claim 15, wherein the operation portion includes a display portion, and
wherein in a case where the operation portion is communicatively connected with the connection portion, in accordance with an operation performed on the operation portion, the display portion displays an image indicating the predetermined operation performed by the operating member in a case where the control portion and the operation portion are unable to communicate with each other.

18. The image forming apparatus according to claim 11, wherein the operation portion is configured to be detachably attached to the apparatus body.

19. The image forming apparatus according to claim 11, further comprising:
a document reading apparatus including a document platen and a reading portion configured to read an image of a document by moving while emitting light to the document placed on the document platen,
wherein the operating member is the reading portion.

20. The image forming apparatus according to claim 11, further comprising:
a document reading apparatus including a reading portion configured to read an image of a document and a conveyance portion configured to convey the document to a reading position at which the document is read by the reading portion,
wherein the operating member is the conveyance portion.

21. The image forming apparatus according to claim 11, further comprising:
an image forming portion configured to form an image on a recording material, and
a processing portion configured to perform a predetermined process on the recording material on which an image has been formed by the image forming portion,
wherein the operating member is the processing portion.
